(19) United States
(12) Patent Application Publication
(10) Pub. No.: US 2009/0285610 A1
(43) Pub. Date: Nov. 19, 2009

(54) FIXING DEVICE AND IMAGE FORMING APPARATUS USING SAME

(75) Inventor: Kazuhisa Edahiro, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/366,760

(22) Filed: Feb. 6, 2009

(30) Foreign Application Priority Data
May 15, 2008 (JP) 2008-127874

(51) Int. Cl. G03G 15/20

(52) U.S. Cl. 399/329; 399/333

(57) ABSTRACT

A fixing device includes an endless fixing belt that is rotatable, a heating device that heats the endless fixing belt, a fixing roller that internally touches the endless fixing belt and a pressure member that abuts against the fixing roller through the endless fixing belt under a given pressure. The endless fixing belt and the pressure member form a fixing nip portion through which a recording medium passes to fix an unfixed toner image on the recording medium. The fixing roller includes a roller body made of metal, and an elastic layer bonded to an outer peripheral surface of the roller body, the elastic layer is formed of a foam having open cells, and both ends of the elastic layer are tapered.

### INCORPORATION BY REFERENCE

This application is based upon and claims the benefit of priority from the corresponding Japanese Patent Application No. 2008-127874, filed May 15, 2008, the entire contents of which is incorporated herein by reference.

### BACKGROUND

1. Field of the Invention

The present invention relates to fixing devices that insert a sheet bearing an unfixed toner image into a nip of a heated roller pair, heat and melt unfixed toner, and fix the toner onto the sheet. Additionally, the present invention relates to image forming apparatuses using an electrophotographic system with the fixing device.

2. Description of the Related Art

In a typical image forming apparatus using an electrophotographic system, usually a heating roller fixing system is used wherein a heat source is incorporated into at least one roller of a fixing roller pair that forms a nip to provide a heating roller. In the system, a sheet bearing an unfixed toner image thereon is inserted into a nip portion of the roller pair to fix toner on the sheet.

In such heating roller fixing systems, the efficiency of heat transmission from the heat source, such as a halogen heater incorporated into the heating roller, to the roller surface is low and the loss of heat is great. Also, a long period of time is required to transmit heat to the roller surface. As a result, power consumption is large and a long warm-up time is required until the roller surface reaches a fixable temperature.

In order to improve the above-mentioned drawbacks, a belt fixing system has been developed wherein a heating member for heating the sheet is provided as a belt or a film which absorbs radiant light from the heat source and thereby generates heat, instead of using a heating roller. With this structure, the heat capacity is reduced as compared to that of conventional heating rollers thereby shortening the warm-up time and reducing the power consumption.

In a color image forming apparatus using the above-mentioned belt fixing system, the fixing belt includes a release layer made of silicon rubber laminated on a front surface side of a thin core member made of nickel. A surface layer of the fixing belt is made of a sponge-like heat insulation material. The elastic deformation of the sponge-like heat insulation material downstream of the nip portion makes it easy to release the sheet after the fixing processing from the fixing belt.

However, where the surface layer of the fixing roller is formed as a sponge with closed cells, the closed cells may expand and burst when the fixing roller is heated through the fixing belt. When a number of the closed cells burst, nipping is not uniformly and properly conducted onto the sheet. As a result, the transmission of heat from the fixing belt to the sheet varies widely, and it is difficult to have a uniform fixing processing on the sheet, it may cause problems such as image defects, peeling defects, or the like.

As an attempt to eliminate the above-mentioned drawback, pressure rollers have been used for the fixing process having sponge-like silicon rubber with open cells arranged concentrically on the outer periphery of a cylindrical core member. In the sponge-like silicon rubber, due to the open cells even if the temperature of the pressure roller increases, due to heating during the fixing processing causing an expansion of air within the open cells, the air is vented. As a result, there is no issue of burst bubbles causing the pressure roller to be deformed.

However, the sponge-like silicon rubber with the open cells, has a reduced tensile strength than the sponge-like silicon rubber with the closed cells. This can cause the sponge-like silicon rubber with the open cells to be released from the fixing roller cored bar due to repeated starting and stopping operations.

In particular, the release is likely to occur at the point of bonding between the silicon rubber and the cored bar at an end where a great stress is generated. For that reason, further improvements in the durability of the fixing rollers is necessary.

### SUMMARY

The present invention provides fixing devices having foam having open cells as an elastic layer of a fixing roller that prevent the elastic layer from being released from the fixing roller and provide not only a uniform fixing processing, but also durability. Additionally, image forming apparatuses including the fixing device are provided.

A fixing device according to an embodiment of the present invention includes:

an endless fixing belt that is rotatable;

a heating device that heats the endless fixing belt;

a fixing roller that internally touches the endless fixing belt; and

a pressure member that abuts the fixing roller through the endless fixing belt under a given pressure,

the endless fixing belt and the pressure member form a fixing nip portion through which a recording medium passes to fix an unfixed toner image on the recording medium, and

the fixing roller includes a roller body made of metal, and an elastic layer bonded to an outer peripheral surface of the roller body, the elastic layer is formed of a foam having open cells, and both ends of the elastic layer are tapered.

An image forming apparatus according to another embodiment of the present invention includes:

an image forming unit that forms a toner image on a recording medium; and

a fixing device that fixes the toner image formed by the image forming unit on the recording medium,

the fixing device having the above-mentioned configuration.

Additional features and advantages are described herein, and will be apparent from the following Detailed Description and the figures.

### BRIEF DESCRIPTION OF THE FIGURES

In the accompanying drawings:

FIG. 1 illustrates a schematic cross-sectional view of an image forming apparatus with a fixing device according to an embodiment of the present invention;

FIG. 2 is a side sectional view illustrating a fixing device according to an embodiment of the present invention;

FIG. 3 is a side sectional view of a fixing roller used in the fixing device of FIG. 2;

FIG. 4 is a partial side sectional view illustrating a right end periphery of FIG. 3 of the fixing roller used in the fixing device according to the embodiment of FIG. 2;

FIG. 5 is a side sectional view illustrating a fixing roller used in a fixing device according to another embodiment of the present invention; and

FIG. 6 is a partial side sectional view illustrating a right end periphery of FIG. 5 of the fixing roller.

### DETAILED DESCRIPTION

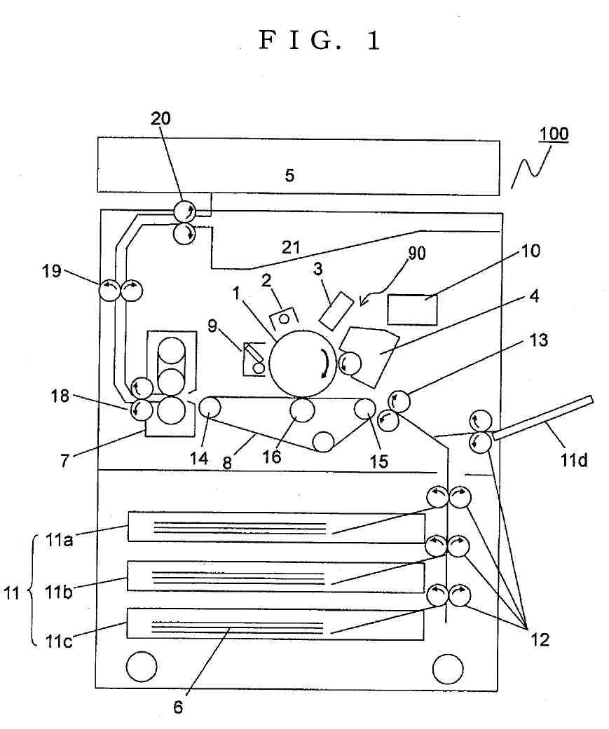

Hereinafter, is a description of an embodiment of the present invention with reference to the accompanying drawings. FIG. 1 illustrates a schematic cross-sectional view of an image forming apparatus with a fixing device according to an embodiment of the present invention. The image forming apparatus 100, by way of example, is a digital multifunction peripheral, in this embodiment. In the image forming apparatus 100, for the copy operation, an image forming unit 90 is positioned above a transport belt 8 within a main body. The image forming unit 90 provides an image based on original image data read by an image read unit 5 through the processes of charging, exposure, development, and transfer.

In the image forming unit 90, a photosensitive drum 1 bearing a visible image (toner image) is positioned, and a toner image formed on the photosensitive drum 1 is transferred to a sheet (recording medium) 6 which is transported by the transport belt 8 and travels adjacent to the image forming unit 90. After the toner image has been fixed onto the sheet 6 in a fixing device 7, the sheet 6 is discharged from the main body of the apparatus. An image forming process is performed with respect to the photosensitive drum 1 while the photosensitive drum 1 rotates clockwise (FIG. 1).

Above the photosensitive drum 1, a charger 2, that charges the photosensitive drum 1 is provided. Also located above and around the photosensitive drum 1 are an exposure unit 3 that exposes image information on the photosensitive drum 1, a developing device 4 that forms the toner image on the photosensitive drum 1, and a cleaning unit 9 that removes a developer (toner) remaining on the photosensitive drum 1.

In use, a surface of the photosensitive drum 1 is uniformly charged by the charger 2 and then irradiated with light by the exposure unit 3 to form an electrostatic latent image on the photosensitive drum 1 according to an image signal. The developing device 4 is filled with an amount of toner, by a toner container 10. The toner is supplied onto the photosensitive drum 1 by means of the developing device 4, and electrostatically stuck thereto, thereby forming a toner image corresponding to the electrostatic latent image formed due to the exposure unit 3.

The sheet 6, to which the toner image is transferred, is located in a sheet container 11 including a plurality of paper feed cassettes 11a, 11b, and 11c that contain the sheets, and a stack bypass (manual tray) lid disposed above those paper feed cassettes 11a, 11b, and 11c. The sheet 6 is supplied onto the transport belt 8 through paper feed rollers 12 and registration rollers 13, and then transported to the photosensitive drum 1. The transport belt 8 is defined by an endless belt formed of a dielectric resin sheet having both ends overlapping with each other and bonded together, or a seamless belt having no seam.

The transport belt 8 is received by a driving roller 14 on a downstream side and a driven roller 15 on an upstream side. When the transport belt 8 starts to rotate counterclockwise in the figure, the sheet 6 is transported onto the transport belt 8 from the registration rollers 13. In this situation, an image write signal turns on, and an image is formed on the photosensitive drum 1 at a specific time. A toner image on the photosensitive drum 1 is then transferred onto the sheet 6 at a transfer nip portion formed by the photosensitive drum 1 and a transfer roller 16 that is applied with a given transfer voltage at a lower portion of the photosensitive drum 1. The sheet 6 is held on the transfer belt 8 by an electrostatic adsorption force.

The sheet 6, onto which the toner image has been transferred, is removed from the transport belt 8 and is then transported to the fixing device 7. The photosensitive drum 1, from which the toner image has been transferred, is now ready for the creation of a new electrostatic latent image which is subsequently performed, and the toner remaining on the surface thereof is removed from the photosensitive drum 1 by the cleaning unit 9. The sheet 6, that has been transported to the fixing device 7 from the transport belt 8, is heated and pressurized so that the toner image is fixed onto the surface of the sheet 6. Thus, a given image is formed. The sheet 6 thereafter passes through transport roller pairs 18 and 19, and is discharged onto a discharge tray 21 from discharge rollers 20.

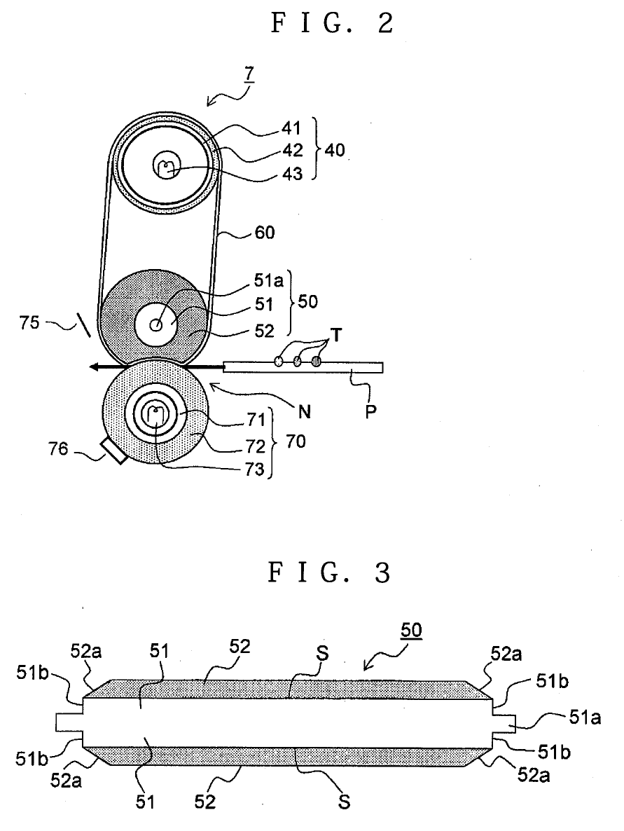

FIG. 2 is a side sectional view illustrating a fixing device according to an embodiment of the present invention. As illustrated in FIG. 2, the fixing device 7 includes an endless fixing belt 60 that rotates clockwise in the figure. The fixing device 7 also includes a heating roller 40 and a fixing roller 50, which internally touch the fixing belt 60 and rotate in the same direction as that of the fixing belt 60, and a pressure roller (pressure member) 70 that rotates counterclockwise in the figure.

The pressure roller 70 abuts against the fixing roller 50 through the fixing belt 60. A fixing nip portion N, that allows a sheet P transported from the image forming unit 90 to pass therethrough downstream, is formed between the fixing belt 60 and the pressure roller 70. A separating plate 75 for releasing the sheet P from the fixing belt 60 is located downstream of the fixing roller 50. A thermistor 76 is positioned in contact with the surface of the pressure roller 70, and another thermistor (not shown) is positioned in contact with the surface of the fixing belt 60. The on/off operation of first and second halogen heaters 43 and 73, which is described later, is controlled using the detection results of those thermistors, thereby controlling the fixing temperature.

The heating roller (heating device) 40 is designed to supply heat to the sheet P that passes through the fixing nip portion N via the fixing belt 60. The heating roller 40 includes a heating roller main body 41 which is cylindrical and thin (for example, 0.5 to 1.0 mm), a coating layer 42 laminated on the peripheral surface of the heating roller main body 41, and the first halogen heater 43, located inside the body 41, as a heat source having substantially the same length as that of the heating roller main body 41.

The heating roller main body 41 is thin, and, therefore, the heating roller main body 41 rapidly increases in temperature when energy is applied to the first halogen heater 43 with the result that the image forming apparatus 100 (see FIG. 1) rapidly starts up at the beginning of operation. In this embodiment, a heater of 1,000 W is used as the first halogen heater 43. The heating roller main body 41 has excellent heat transmission and is made of a metal material such as Al (aluminum) or Fe (iron) so that the temperature distribution in the longitudinal direction is substantially uniform.

The coating layer 42 is designed to prevent the peripheral surface of the heating roller 40 from being damaged due to contact with the fixing belt 60. The coating layer 42 can be made of, for example, tetrafluoroethylene perfluoroalkyl vinyl ether copolymer (PFA), polytetrafluoroethylene (PTFE), or the like.

The fixing roller 50 is designed to fix toner T to the sheet P, which has been transported to the fixing nip portion N, in cooperation with the fixing belt 60 and the pressure roller 70. The fixing roller 50 is rotationally driven by the drive motor (not shown), thereby supporting the fixing belt 60 so that it can circle therearound.

The fixing roller 50 includes a cylindrical or columnar cored bar (roller body) 51 made of a metal material such as Al or Fe having a plated surface (in FIG. 2, the cored bar 51 is formed of a columnar material) and an elastic layer 52 formed of a foam cylindrical body, which is concentrically formed, on the outer peripheral surface of the cored bar 51. Also, the cored bar 51 has a rotating shaft 51a connected to the drive motor.

In this embodiment, the elastic layer 52 is made of water-foamed silicon rubber (foam) with a large number of open cells. Water, predetermined additive, and a catalyst are mixed in a liquid silicon rubber base polymer. The mixture is heated. After the water is evaporated, an open cell structure is formed, whereby the water-foamed silicon rubber is formed.

Specifically, as described in JP 2004-70159 A, is a first composition formed of 0.1 to 20 parts by weight of a hydrophilic polymer, 10 to 200 parts by weight of water, and a slight amount of a curing catalyst formed of a platinum compound or the like with respect to 100 parts by weight of a liquid silicon base polymer is prepared. Simultaneously, 100 parts by weight of a liquid silicon base polymer, 0.1 to 20 parts by weight of a hydrophilic polymer, 10 to 200 parts by weight of water, and SiH polymer as a crosslinking agent are mixed, whereby a second composition is prepared. Then, equal amounts of the first composition and the second composition stirred, whereby a blended material is provided.

The blended material is loaded into a die, and molded into a predetermined shape by heating for 10 to 30 hours at a temperature such that the silicon base polymer is substantially not cured and water is not evaporated, that is, 100° C. or lower, preferably 50 to 80° C. Next, the molded article is heated at 120 to 250° C., preferably 120 to 180° C., for 1 to 5 hours to evaporate the water contained in the article.

Upon the evaporation of the moisture, respective isolated air bubbles are connected to each other and a foam having open cells which have openings toward the exterior is obtained. Then, the foam is cured by heating at 180 to 300° C., preferably 200 to 250° C., for 2 to 8 hours, whereby a water-foamed silicon rubber is formed.

The liquid silicon rubber base polymer is available, for example, “XE15-B7503A” and “XE15-B7503B”, is available from GE Toshiba Silicones Co., Ltd, and “DY39-1119A” and “DY39-1119B”, is available from Dow Corning Toray Co., Ltd.

Examples of the hydrophilic polymer include: polymers of alkali metal salts of acrylic acids or methacrylic acids; polyalkylene glycol, in particular, polymers of acrylic acids or methacrylic acids, which are obtained by grafting polyethylene glycols; polyalkylene glycol, in particular, polyesters or polyamides, which are obtained by blending or copolymerizing polyethylene glycols; and N-vinyl carboxylic acid amide-based crosslinked polymers.

As the first composition obtained by adding a hydrophilic polymer, water, and a curing catalyst to a liquid silicon base polymer, for example, “XE15-B8400A” manufactured by GE Toshiba Silicones is an example. As to the second composition obtained by adding a hydrophilic polymer, water, and a crosslinking agent to a liquid silicon base polymer, for example, “XE15-B8400B” manufactured by GE Toshiba Silicones is an example.

Then, the water-foamed silicon rubber provided with a large number of open cells is applied to the fixing roller 50 as the elastic layer 52.

The fixing belt 60 is placed around the peripheral surface of the heating roller 40 heated by the first halogen heater 43, and heated by heat transmission from the peripheral surface of the heating roller 40. The fixing belt 60 supplies heat obtained by the heat transmission to the toner T on the sheet P to melt the toner T, and subjects the toner T to a fixing process. The fixing belt 60 is placed in tension between the heating roller 40 and the fixing roller 50, and circles around the heating roller 40 and the fixing roller 50 due to rotation of the fixing roller 50 about the axial core thereof being driven by the drive motor.

The fixing belt 60 can include a thinly stretched core belt (not shown) made of Ni (nickel) or heat resistant polyimide resin, a silicon rubber layer (not shown) laminated on the surface side of the core belt, and a coating layer (not shown) laminated on the silicon rubber layer.

In this embodiment, when the core belt is made of, for example, Ni, the thickness can be, for example, 30 μm. On the other hand, when the core belt is made of polyimide resin, the thickness can be set to, for example, 90 μm. Also, the thickness of the silicon rubber layer can be, for example, 200 to 300 μm. The thickness of the core belt is not limited to the above-mentioned numeric value, but appropriate thicknesses can be set according to the condition such as device configuration.

The coating layer is made of fluorine resin such as PFA or PTFE, and coated on the surface of the silicon rubber layer. Alternatively, the coating layer is formed by coating the silicon rubber layer with a tube made of fluorine resin. The use of the coating layer makes it easier to release the sheet P from the fixing belt 60 after the fixing processing.

The pressure roller 70 faces the fixing roller 50 and the peripheral surface of the pressure roller 70 is pressed against the fixing belt 60. The fixing nip portion N is formed between the pressure roller 70 and the fixing belt 60. The elastic layer 52 of the fixing roller 50, which is made of water-foamed silicon rubber, is elastically deformed, and sandwiches the sheet P with the fixing nip portion N, under pressure due to its elastic nature. The fixing nip portion N allows the toner T to be fixed to the sheet P.

The pressure roller 70 includes a piped cored bar 71 that is plated using Al or Fe, an elastic cylindrical body 72 made of solid (that is, not foam) silicon rubber which is fitted on the outer peripheral surface of the cored bar 71. A second halogen heater 73 is located within the cored bar 71. A coating layer (not shown) made of a fluorine resin, such as laminated PFA or PTFE, is formed on the outer peripheral surface of the elastic cylindrical body 72. The coating layer can be formed by coating the elastic cylindrical body 72 with a tube made of fluorine resin.

The second halogen heater 73 is located within the piped cored bar 71 as with the heating roller 40. The sheet P, located at the fixing nip portion N, has a rear surface that is heated by the second halogen heater 73, thereby enabling the fixing processing to be effectively realized. In this embodiment, the second halogen heater 73 applied to the pressure roller 70 is equipped with a heater of 600 W that is smaller in wattage than the first halogen heater 43 used in the heating roller 40. The pressure roller 70 is urged upward by means of a spring (not shown).

The elastic cylindrical body 72 is formed on the cored bar 71. The elastic cylindrical body 72 can exert excellent fixing pressure on the toner on the sheet P at the fixing nip portion N due to the elastic nature thereof.

The elastic layer 52 of the fixing roller 50 is made of water-foamed silicon rubber having a large number of open cells. Therefore, even if the fixing roller 50 is heated, and thus air within the bubbles is expanded by the heat, the expanded air is discharged to the external from the elastic layer 52 through the open cells.

Accordingly, the elastic layer 52 is not expanded and deformed by an expansion of air within the bubbles, nor are the bubbles destroyed by an expansion of the air. The elastic layer 52 is always ensured of having substantially the same shape, and hence an excellent fixing nip portion N for fixing the sheet P is always ensured.

The foam, having the open cells that is used for the elastic layer 52 of the fixing roller 50 (foam with open cells), has a lower tensile strength than the foam having the closed cells (foam with closed cells). Therefore, due to the load created by the repetition of the start/stop operation of the device, there is a risk that the elastic layer 52 can be released from the cored bar 51. In particular, the release is liable to occur on both ends of the elastic layer 52 in the width direction where a great stress is generated.

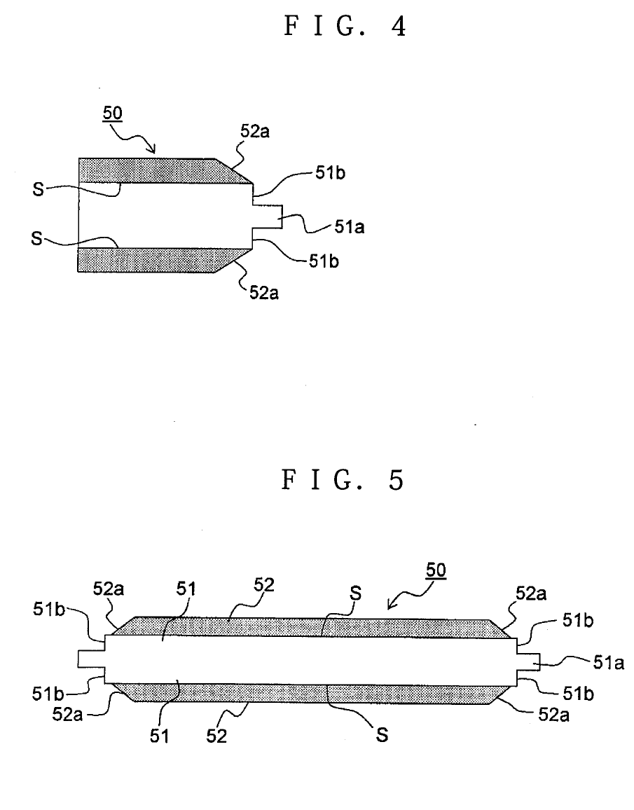

Under the above-mentioned circumstances, both ends 52a of the elastic layer 52 are tapered. FIG. 3 is a side sectional view of a fixing roller used in the fixing device according to this embodiment. FIG. 4 is a partial side sectional view illustrating a right end periphery of FIG. 3 in the fixing roller according to this embodiment. The configuration of the fixing roller 50 is identical between both of the right and left ends of FIG. 3, and therefore only the right end periphery is illustrated in FIG. 4.

As illustrated in FIG. 3, the length of a bonding plane S of the elastic layer 52 with the cored bar 51 in the fixing roller axial direction (lateral direction in the figure) is substantially the same as the length of the cored bar 51 surface in the fixing roller axial direction, and both ends of the bonding plane S are identical to both ends 51b of the cored bar 51 for bonding. Additionally, both ends 52a of the elastic layer 52 in the fixing roller axial direction (lateral direction) are tapered with respect to the cored bar 51. With the above configuration, even if the fixing roller 50 is pressed by the pressure roller 70, there is a reduction in a stress at both ends of the elastic layer 52 outward in the axial direction is reduced. This thereby makes it possible to prevent both ends of the bonding plane S from being released from the cored bar 51.

With this structure, it is possible to have uniform pressure at the fixing nip portion N. Also, it is possible to prevent the elastic layer from being released from the fixing roller 50. Accordingly, a uniform fixing processing is provided, and the durability can be improved.

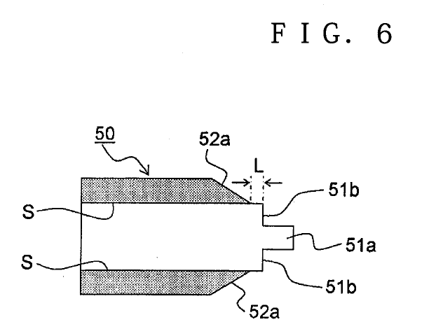

FIG. 5 is a side sectional view illustrating a fixing roller used in a fixing device according to another embodiment of the present invention. FIG. 6 is a partial side sectional view illustrating a right end periphery of FIG. 5 in the fixing roller according to this embodiment. The configuration of the fixing roller 50 is identical between both of the right and left ends of FIG. 5. Therefore, only the right end periphery is illustrated in FIG. 6.

In this embodiment, as illustrated in FIG. 5, the length of the bonding plane S of the elastic layer 52 in the fixing roller axial direction (lateral direction) is shorter than the length of the cored bar 51 in the width direction. As illustrated in FIG. 6, the elastic layer 52 is bonded to the cored bar 51 in such a manner that both ends of the bonding plane S in the fixing roller axial direction are located on an inner side with respect to the both ends 51b of the cored bar 51 by a given interval L. The remaining structure is identical with those in the first embodiment, and therefore their description is omitted.

According to this embodiment, a gap, interval L, is provided between the bonding plane S of the elastic layer 52 and each of the ends 51b of the cored bar 51. Therefore, even if the pressure roller 70 pressurizes the elastic layer 52, the bonding plane S of the elastic layer 52 is prevented from projecting outward from the both ends 51b of the cored bar 51. With this structure, the release of the elastic layer 52 can be more effectively prevented, and durability can be more improved. The interval L can be, for example, 1 mm. But the distance is not particularly restricted, and can be appropriately set according to a material of the elastic layer 52, the area of the fixing nip portion N in the fixing roller axial direction, the bonding property with the cored bar 51, and other structural considerations.

In the above-mentioned embodiment, the foam with open cells, forming the elastic layer 52 of the fixing roller 50, is made of water-foamed silicon rubber. However, the foam is not limited to water-foamed silicon rubber, and for example, one can use a microballoon silicon rubber as the foam, in which microcapsules made of synthetic resin which is mixed in a raw material used to manufacture silicon rubber are subjected to defoaming processing to form open cells. The microcapsule is obtained by encapsulating a volatile solvent in an outer shell formed of a thermoplastic synthetic resin having a diameter of 5 to 30 μm. Examples of the thermoplastic synthetic resin include ethylene, styrene, vinyl acetate, vinyl chloride, vinylidene chloride, acrylonitrile, butadiene, chloroprene, polyamide, polyethylene terephthalate. In addition, as the volatile solvent, hydrocarbons such as butane and isobutane can be used. The microcapsules can be made of, for example, “WU#642” available from Expancel Corp. or “Matsumoto microsphere-F-30D” available from Matsumoto Yushi-Seiyaku Co., Ltd.

The microcapsules are mixed with, for example, liquid silicon rubber base polymer, and heated at a temperature of not greater than about 300° C. while being processed. As a result, the volatile material in the microcapsules volatilizes, breaking the outer shells, and thereby leaks to the outside. This allows a macroballoon silicon rubber formed with the open cell to be produced.

The present invention is not limited to the above-mentioned embodiments, and various changes may be made without departing from the scope of the present invention. For example, in the above-mentioned embodiments, the second halogen heater 73 is located in the pressure roller 70. However, when the amount of heat that is necessary and sufficient is provided by the heat roller 40, the second halogen heater 73 does not need to be located in the pressure roller 70. The method for the heating roller 40 is not particularly limited, and, for example, an induction heating coil can be used for heating. By way of another example, in the above-mentioned embodiments, the fixing roller 50 is rotated by the drive motor. Alternatively, the heating roller 40 can be rotated by the drive motor. With respect to the inclined angle at both ends 52a of the elastic layer 52 with respect to the surface of the cored bar 51, this is not particularly restricted, and for example, the inclined angle can be closer to a right angle.

It should be noted that the fixing device of the present invention can be used in various copying machines, such as, a digital copying machine, a tandem-type color copying machine, or an analog-type monochrome copying machine, or an image forming apparatus using an electrophotographic process such as a facsimile machine or a laser printer.

Hereinafter, by way of example and not limitation, a detailed example and investigation of the present invention is provided.

### EXAMPLE

For use in the image forming apparatus 100 equipped with the fixing device 7 illustrated in FIG. 1, the release state of the elastic layer 52 of the fixing roller 50 was investigated.

The heating roller 40 used in the heating roller main body 41 is made of Al which is 0.7 mm thick and is coated with the coating layer 42 of PFA so as to have an outer diameter of φ22 mm. The first halogen heater 43 is 1,000 W. The fixing belt 60 is Ni coated with a silicon rubber layer to have an outer diameter of φ55 mm.

The elastic layer 52 of the fixing roller 50 is made of liquid silicon rubber, silicon sponge made of a foam with closed cells, water-foamed silicon rubber made of a foam with open cells, and microballoon silicon rubber. The fixing roller 50 has a cored bar 51 made of Al bonded to an elastic layer 52 that is 6 mm thick so as to have an outer diameter of φ32 mm.

The pressure roller 70 has an elastic cylindrical body 72 made of silicon rubber which is 3.5 mm thick and bonded to the surface of the cored bar 71 made of Al so as to have an outer diameter of φ35 mm. A 600 W heater is used as the second halogen heater 73.

It has previously been determined that the tensile strength of the material used in the elastic layer 52, liquid silicon rubber is 1 to 3 MPa, and silicon sponge with closed cells is 0.5 to 0.8 MPa. Both the tensile strengths of water-foamed silicon rubber formed of a foam with open cells and microballoon silicon rubber are 0.4 MPa. Accordingly, the foam with open cells has a reduced tensile strength than the foam with closed cells.

A comparative example is now described. The elastic layer 52 as used is made of liquid silicon rubber and silicon sponge with closed cells. Both ends 52a of the elastic layer 52 are formed so as to be perpendicular to the surface of the cored bar 51 and the length of the elastic layer 52 in the fixing roller axial direction is the same as the length of the outer peripheral surface portion of the cored bar 51 in the axial direction. The elastic layer 52 is bonded so that both ends of the bonding plane S in the fixing roller axial direction are identical with the both ends 51b of the cored bar 51 to provide the fixing device of the comparative example. Using the above-mentioned configuration, it was found that there was a release on both ends of the bonding plane S of the elastic layer 52 when approximately 100,000 sheets are printed, in both of the foams.

Testing of an example of the present invention is described. With the use of water-foamed silicon rubber and microballoon silicon rubber, as described in the above-mentioned embodiment (refer to FIGS. 5 and 6), the length of the bonding plane S of the elastic layer 52 in the axial direction is shorter than the length of the cored bar 51 by 2 mm. Also, both ends 52a are tapered. The bonding plane S is bonded so as to be located on the inner side with respect to the both ends 51b of the cored bar 51 by 1 mm (L=1 mm), respectively, to provide the fixing device of this example. It was found that there was no release on the bonding plane S of the elastic layer 52 even if approximately 300,000 sheets are printed in both of the foams.

From the above-mentioned results, when the water-foamed silicon rubber made of a foam with open cells and the microballoon silicon rubber are used as the elastic layer 52 of the fixing roller 50, with the structure of the above-mentioned example, the elastic layer 52 can be prevented from being released from the cored bar 51 and excellent durability is provided.

The fixing device according to an embodiment of the present invention includes:

the endless fixing belt that is rotatable;

the heating device that heats the endless fixing belt;

the fixing roller that internally touches the endless fixing belt; and

the pressure member that abuts against the fixing roller through the endless fixing belt under a given pressure,

the endless fixing belt and the pressure member form the fixing nip portion through which the recording medium passes to fix the unfixed toner image borne on the recording medium, and

the fixing roller includes a roller body made of metal and an elastic layer is bonded to the outer peripheral surface of the roller body, the elastic layer being formed of the foam having the open cells, and the both ends of the elastic layer are tapered.

According to the above structure, the outer peripheral surface of the roller body of the fixing roller is bonded to the elastic layer which is the foam having the open cells, and whose ends are tapered, thereby making it possible to uniformly pressurize the fixing nip portion. The elastic layer can also be prevented from being released from the fixing roller. Accordingly, an improvement in durability of the device can also be achieved.

Further, in the fixing device having the above structure, the elastic layer is preferably bonded on the outer peripheral surface of the roller body and located inside of the ends in the axial direction.

With the above structure, a release of the elastic layer can be more effectively prevented and durability improved.

In the fixing device having the above structure, the foam may be made of water-foamed silicon rubber or micro balloon silicon rubber.

Through the use of foam, the cells are more effectively prevented from breaking and the fixing nip portion can be more uniformly pressurized.

The image forming apparatus according to another embodiment of the present invention includes:
the image forming unit that forms the toner image on the recording medium; and
the fixing device that fixes the toner image formed by the image forming unit on the recording medium,
in which the fixing device has the above structure.

In the image forming apparatus having the above structure, by incorporating the above-mentioned fixing device, it is possible to perform image formation while preventing poor image from occurring due to a failure to provide uniform pressure at the fixing nip portion.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fixing device, comprising:
an endless fixing belt that is rotatable;
a heating device that heats the endless fixing belt;
a fixing roller that internally touches the endless fixing belt;
a pressure member that abuts against the fixing roller through the endless fixing belt under a given pressure,
the endless fixing belt and the pressure member form a fixing nip portion through which a recording medium passes to fix an unfixed toner image on the recording medium; and
the fixing roller includes a roller body made of metal, and an elastic layer bonded to an outer peripheral surface of the roller body, the elastic layer is formed of a foam having open cells, and both ends of the elastic layer are tapered.

2. The fixing device according to claim 1, wherein the elastic layer is bonded on the outer peripheral surface of the roller body and located inside of the ends in an axial direction.

3. The fixing device according to claim 1, wherein the foam is water-foamed silicon rubber.

4. The fixing device according to claim 1, wherein the foam is micro balloon silicon rubber.

5. An image forming apparatus, comprising:
an image forming unit that forms a toner image on a recording medium; and
a fixing device that fixes the toner image formed by the image forming unit on the recording medium, the fixing device comprises:
an endless fixing belt that is rotatable;
a heating device that heats the endless fixing belt;
a fixing roller that internally touches the endless fixing belt;
a pressure member that abuts against the fixing roller through the endless fixing belt under a given pressure,
the endless fixing belt and the pressure member form a fixing nip portion through which a recording medium passes to fix an unfixed toner image on the recording medium, and
the fixing roller includes a roller body made of metal, and an elastic layer bonded to an outer peripheral surface of the roller body, the elastic layer is formed of a foam having open cells, and both ends of the elastic layer are tapered.

6. The image forming apparatus according to claim 5, wherein the elastic layer is bonded on the outer peripheral surface of the roller body and located inside of the ends in an axial direction.

7. The image forming apparatus according to claim 5, wherein the foam is water-foamed silicon rubber.

8. The image forming apparatus according to claim 5, wherein the foam is micro balloon silicon rubber.

9. A fixing device, comprising:
a fixing belt that is rotatable;
a heater device that heats the fixing belt;
a fixing roller;
a pressure member,
the fixing belt and the pressure member form a fixing nip portion through which a recording medium passes to fix an unfixed toner image on the recording medium; and
the fixing roller includes a roller body made of metal, and an elastic layer bonded to an outer peripheral surface of the roller body, the elastic layer is formed of a foam having open cells, and both ends of the elastic layer are tapered.
